(19) United States
(12) Patent Application Publication
(10) Pub. No.: US 2019/0132529 A1
(43) Pub. Date: May 2, 2019

(54) IMAGE PROCESSING APPARATUS AND IMAGE PROCESSING METHOD

(71) Applicant: CANON KABUSHIKI KAISHA, Tokyo (JP)

(72) Inventor: Hironao Ito, Yokohama-shi (JP)

(21) Appl. No.: 16/160,071

(22) Filed: Oct. 15, 2018

(30) Foreign Application Priority Data
Oct. 30, 2017 (JP) 2017-209564

(51) Int. Cl. H04N 5/247; H04N 7/18; H04N 13/189; G06F 3/0481; G06T 15/20; H04N 13/117; H04N 13/243; G06T 1/00

(52) U.S. Cl. CPC H04N 5/247; H04N 7/181; H04N 13/189; G06T 1/0007; G06T 15/205; H04N 13/117; H04N 13/243; G06F 3/04815

(57) ABSTRACT

An image processing apparatus obtains a three-dimensional shape model representing a shape of an object captured from a plurality of directions by a plurality of image-capturing apparatuses arranged at different positions, obtains, as an image used to generate a virtual viewpoint image including at least one of a plurality of objects captured by the plurality of image-capturing apparatuses, an image based on image-capturing by an image-capturing apparatus selected based on the positional relationship between the plurality of objects, the position and orientation of an image-capturing apparatus included in the plurality of image-capturing apparatuses, and the position of a designated virtual viewpoint, and generates the virtual viewpoint image based on the obtained three-dimensional shape model and the obtained image.

### BACKGROUND OF THE INVENTION

### Field of the Invention

The present invention relates to an image processing system including a plurality of cameras to capture an object from a plurality of directions.

### Description of the Related Art

Recently, attention is paid to a technique of placing a plurality of cameras in different positions, performing synchronized image-capturing at multiple viewpoints, and generating a virtual viewpoint content by using a plurality of viewpoint images obtained by the image-capturing operation. Since such a technique allows a user to view, for example, a scene capturing the highlight of a soccer game or a basketball game from various angles, the user can enjoy a realistic feel compared to a normal image.

The generation and viewing of a virtual viewpoint content based on multi-viewpoint images can be implemented by collecting images captured by a plurality of cameras in an image processing unit such as a server, performing processes such as three-dimensional model generation and rendering by the image processing unit, and transmitting the resultant image to a user terminal. That is, an image at a virtual viewpoint designated by the user is generated by combining a texture image and an object three-dimensional model generated from images captured by a plurality of cameras.

However, when generating a virtual viewpoint image, there may be pixels (to be referred to as ineffective pixels hereinafter) corresponding to an area that cannot be viewed from cameras placed in the system owing to overlapping of objects such as players, and some pixels of the virtual viewpoint image may not be generated.

According to Japanese Patent Laid-Open No. 2005-354289, a material image to generate a virtual viewpoint image is obtained from one camera selected from a plurality of cameras, and a virtual viewpoint image is generated. Then, it is determined whether the virtual viewpoint image includes ineffective pixels, and if so, a material image is obtained from another camera to compensate for the ineffective pixels. Even if ineffective pixels exist in an image obtained by one camera owing to occlusion, a virtual viewpoint image can be generated by sequentially obtaining images from a plurality of cameras.

To generate a high-quality virtual viewpoint image in an image processing system including a plurality of cameras, the number of cameras, the image size of each camera, and the number of pixel bits are assumed to increase. When the generation target is, for example, a sport, higher-speed virtual viewpoint image generation processing is required to generate a virtual viewpoint image with almost no delay from real time.

However, generation of a virtual viewpoint image takes a long time in the method of obtaining data sequentially from a plurality of cameras until all ineffective pixels are compensated for, as in Japanese Patent Laid-Open No. 2005-354289, because the amount of data to be obtained increases and determination of the presence/absence of ineffective pixels is repeated.

### SUMMARY OF THE INVENTION

An embodiment of the present invention has been made in consideration of the above problems, and enables to efficiently obtain an image and implement high-speed image generation processing when generating a virtual viewpoint image.

According to one aspect of the present invention, there is provided an image processing apparatus comprising: a model obtaining unit configured to obtain a three-dimensional shape model representing a shape of an object captured from a plurality of directions by a plurality of image-capturing apparatuses arranged at different positions; a viewpoint obtaining unit configured to obtain viewpoint information representing a virtual viewpoint; an image obtaining unit configured to obtain, as an image used to generate a virtual viewpoint image including at least one of a plurality of objects captured by the plurality of image-capturing apparatuses, an image based on image-capturing by an image-capturing apparatus selected based on a positional relationship between the plurality of objects, a position and orientation of an image-capturing apparatus included in the plurality of image-capturing apparatuses, and a position of the virtual viewpoint represented by the viewpoint information obtained by the viewpoint obtaining unit; and an image generation unit configured to generate the virtual viewpoint image based on the three-dimensional shape model obtained by the model obtaining unit and the image obtained by the image obtaining unit.

According to another aspect of the present invention, there is provided an image processing method comprising: obtaining a three-dimensional shape model representing a shape of an object captured from a plurality of directions by a plurality of image-capturing apparatuses arranged at different positions; obtaining viewpoint information representing a virtual viewpoint; obtaining, as an image used to generate a virtual viewpoint image including at least one of a plurality of objects captured by the plurality of image-capturing apparatuses, an image based on image-capturing by an image-capturing apparatus selected based on a positional relationship between the plurality of objects, a position and orientation of an image-capturing apparatus included in the plurality of image-capturing apparatuses, and a position of the virtual viewpoint represented by the obtained viewpoint information; and generating the virtual viewpoint image based on the obtained three-dimensional shape model and the obtained image.

According to another aspect of the present invention, there is provided a non-transitory computer-readable medium storing a program configured to cause a computer to execute an image processing method, the image processing method comprising: obtaining a three-dimensional shape model representing a shape of an object captured from a plurality of directions by a plurality of image-capturing apparatuses arranged at different positions; obtaining viewpoint information representing a virtual viewpoint; obtaining, as an image used to generate a virtual viewpoint image including at least one of a plurality of objects captured by the plurality of image-capturing apparatuses, an image based on image-capturing by an image-capturing apparatus selected based on a positional relationship between the plurality of objects, a position and orientation of an image-capturing apparatus included in the plurality of image-capturing apparatuses, and a position of the virtual viewpoint represented by the obtained viewpoint information; and generating the virtual viewpoint image based on the obtained three-dimensional shape model and the obtained image.

Further features of the present invention will become apparent from the following description of exemplary embodiments (with reference to the attached drawings).

### BRIEF DESCRIPTION OF THE DRAWINGS

FIG. 1 is a block diagram exemplifying the arrangement of an image processing system 100;

FIG. 2 is a block diagram showing the relationship between the internal blocks of a back end server 270 and peripheral devices;

FIG. 3 is a block diagram showing a data obtaining unit 272;

FIG. 4 is a schematic view showing a state in which two objects exist in a stadium where a plurality of cameras are arranged;

FIG. 5 is an enlarged view of the area of objects 400 and 401;

FIG. 6 is a flowchart showing processing of obtaining an image for generating a virtual viewpoint image according to the first embodiment;

FIG. 7 is a block diagram showing the hardware configuration of a camera adapter 120;

FIG. 8 is a block diagram showing the relationship between the internal blocks of a back end server 270 and peripheral devices;

FIG. 9 is a block diagram showing a data obtaining unit 272a;

FIG. 10 is a view showing the texture image of an object 401;

FIG. 11 is a view showing pixels necessary to generate an image at a virtual viewpoint 500 in the texture image of the object 401;

FIG. 12 is a flowchart showing processing of obtaining an image for generating a virtual viewpoint image according to the second embodiment; and

FIG. 13 is a block diagram showing the relationship between the internal blocks of a front end server 230 and peripheral devices.

### DESCRIPTION OF THE EMBODIMENTS

Embodiments according to the present invention will be described in detail below with reference to the drawings.

Arrangements described in the following embodiments are merely examples, and the present invention is not limited to the illustrated arrangements.

### First Embodiment

<Outline of Image Processing System>

An image processing system as a virtual viewpoint video system adopted in the first embodiment will be explained. The virtual viewpoint video system is a system that performs image-capturing and sound collection by placing a plurality of cameras and microphones in a facility such as an arena (stadium) or a concert hall, and generates a virtual viewpoint video.

<Description of Image Processing System 100>

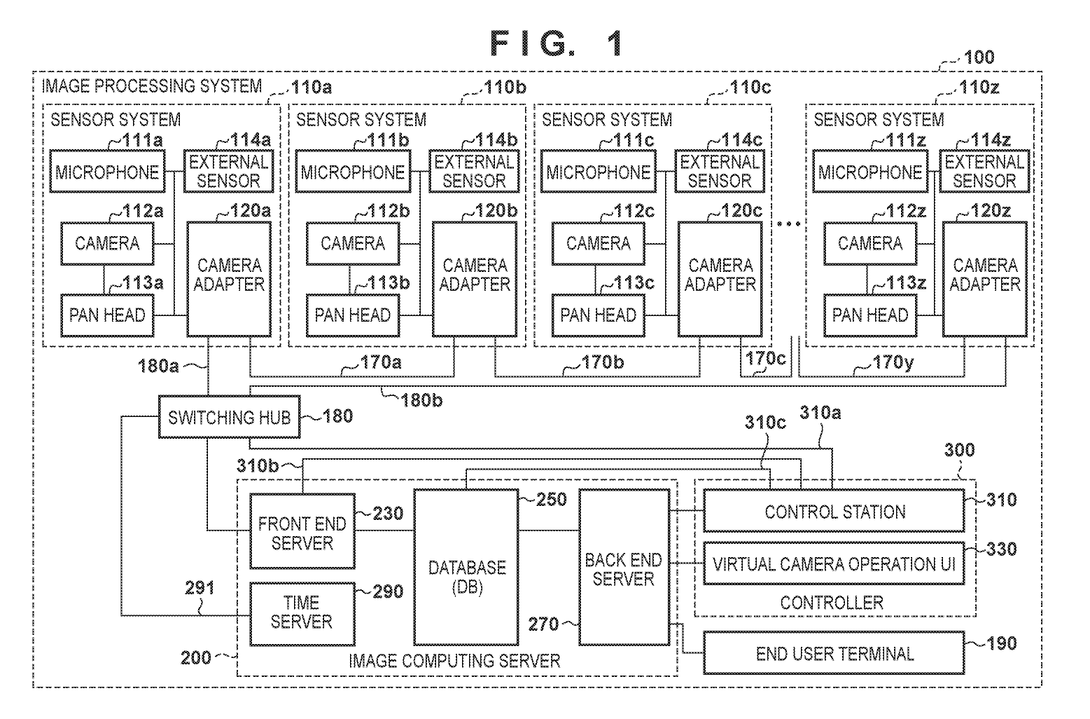

FIG. 1 is a block diagram exemplifying the arrangement of an image processing system 100 as a virtual viewpoint video generation system. Referring to FIG. 1, the image processing system 100 includes sensor systems 110a to 110z, an image computing server 200, a controller 300, a switching hub 180, and an end user terminal 190.

<Description of Controller 300>

The controller 300 includes a control station 310 and a virtual camera operation UI 330. The control station 310 performs management of operation states, parameter setting control, and the like for each block constituting the image processing system 100 via networks 310a to 310d, 180a, 180b, and 170a to 170y.

<Description of Sensor System 110>

An operation of transmitting 26 sets of images and sounds obtained by the sensor systems 110a to 110z from the sensor system 110z to the image computing server 200 will be described.

In the image processing system 100, the sensor systems 110a to 110z are connected by a daisy chain. The 26 sets of systems from the sensor systems 110a to 110z will be expressed as sensor systems 110 without distinction unless specifically stated otherwise. In a similar manner, devices in each sensor system 110 will be expressed as a microphone 111, a camera 112 as an image-capturing apparatus, a pan head 113, and a camera adapter 120 unless specifically stated otherwise. Note that the number of sets of sensor systems is described as 26. However, the number of sensor systems is merely an example and is not limited to this. A term “image” includes the concepts of both a moving image and a still image unless specifically stated otherwise. That is, the image processing system 100 can process both a still image and a moving image.

An example in which a virtual viewpoint content provided by the image processing system 100 includes both a virtual viewpoint image and a virtual viewpoint sound will mainly be described. However, the present invention is not limited to this. For example, the virtual viewpoint content need not include a sound. Also, for example, the sound included in the virtual viewpoint content may be a sound collected by a microphone closest to a virtual viewpoint. Although a description of a sound will partially be omitted for the sake of descriptive simplicity, this embodiment assumes that an image and a sound are processed together basically.

Each of the sensor systems 110a to 110z includes a corresponding one of cameras 112a to 112z. That is, the image processing system 100 includes a plurality of cameras to capture an object from a plurality of directions. The plurality of sensor systems 110 are connected to each other by a daisy chain.

The sensor system 110 includes the microphone 111, the camera 112, the pan head 113, and the camera adapter 120. However, the arrangement is not limited to this. An image captured by the camera 112a undergoes image processing to be described later by the camera adapter 120a, and then is transmitted to the camera adapter 120b of the sensor system 110b via a daisy chain 170a together with a sound collected by the microphone 111a. The sensor system 110b transmits a collected sound and a captured image to the sensor system 110c together with the image and sound obtained from the sensor system 110a.

By continuing the above-described operation, images and sounds obtained by the sensor systems 110a to 110z are transmitted from the sensor system 110z to the switching hub 180 using the network 180b and subsequently transmitted to the image computing server 200.

Note that the cameras 112a to 112z and the camera adapters 120a to 120z are separated, but may be integrated in a single housing. In this case, the microphones 111a to 111z may be incorporated in the integrated camera 112 or may be connected to the outside of the camera 112.

Image processing by the camera adapter 120 will be described next. The camera adapter 120 separates an image captured by the camera 112 into a foreground image and a background image. For example, the camera adapter 120 separates a captured image into a foreground image of an extracted moving object such as a player and a background image of a still object such as grass. The camera adapter 120 outputs the foreground image and the background image to another camera adapter 120.

Foreground images and background images generated by the respective camera adapters are transmitted to the camera adapters 120a to 120z and output from the camera adapter 120z to the image computing server 200. The image computing server 200 collects the foreground images and background images generated from the images captured by the respective cameras 112.

<Description of Image Computing Server 200>

The arrangement and operation of the image computing server 200 will be described next. The image computing server 200 processes data obtained from the sensor system 110z.

The image computing server 200 includes a front end server 230, a database 250 (to be sometimes referred to as a DB hereinafter), a back end server 270, and a time server 290.

The time server 290 has a function of distributing a time and a synchronization signal. The time server 290 distributes a time and a synchronization signal to the sensor systems 110a to 110z via the switching hub 180. Upon receiving the time and the synchronization signal, the camera adapters 120a to 120z perform image frame synchronization by genlocking the cameras 112a to 112z based on the time and the synchronization signal. That is, the time server 290 synchronizes the image-capturing timings of the plurality of cameras 112. Accordingly, the image processing system 100 can generate a virtual viewpoint image based on the plurality of images captured at the same timing, and thus can suppress lowering of the quality of the virtual viewpoint image caused by a shift in image-capturing timings.

The front end server 230 obtains from the sensor system 110z foreground images and background images captured by the respective cameras. The front end server 230 generates the three-dimensional model of the object using the obtained foreground images captured by the respective cameras. As the method of generating a three-dimensional model, for example, a Visual Hull method is assumed. According to the Visual Hull method, a three-dimensional space where a three-dimensional model exists is divided into a small cube. The cube is projected to the silhouette of a foreground image captured by each camera. If there is even one camera for which the cube does not fit in the silhouette area, the cube is cut and the remaining cube is generated as a three-dimensional model. Such a three-dimensional model representing the shape of an object will be referred to as an object three-dimensional model.

Note that the means for generating an object three-dimensional model may be another method, and the method is not particularly limited. Assume that the object three-dimensional model is expressed by points each having position information of x, y, and z in a three-dimensional space in the world coordinate system that uniquely represents an image-capturing target space. Also, assume that the object three-dimensional model includes even information representing an outer hull (to be referred to as hull information hereinafter) that is the peripheral area of the object three-dimensional model. The peripheral area is, for example, an area of a predetermined shape containing an object. In this embodiment, the hull information is represented by a cube surrounding the outside of the shape of the object three-dimensional model. However, the shape of the hull information is not limited to this.

The front end server 230 stores the foreground images and background images captured by the respective cameras 112 and the generated object three-dimensional model in the database 250. The front end server 230 creates a texture image for texture mapping of the object three-dimensional model based on the images captured by the respective cameras 112, and stores it in the database 250. Note that the texture image stored in the database 250 may be, for example, a foreground image or a background image, or may be an image newly created based on them.

The back end server 270 functions as an image processing apparatus that receives designation of a virtual viewpoint from the virtual camera operation UI 330. Based on the designated virtual viewpoint, the back end server 270 reads out from the database 250 images and a three-dimensional model necessary to generate a virtual viewpoint image, and performs rendering processing, thereby generating a virtual viewpoint image.

Note that the arrangement of the image computing server 200 is not limited to this. For example, at least two of the front end server 230, the database 250, and the back end server 270 may be integrated. Also, there may be a plurality of at least one of the front end server 230, the database 250, and the back end server 270. A device other than the above-described devices may be included at an arbitrary position in the image computing server 200. Further, at least some of the functions of the image computing server 200 may be imparted to the end user terminal 190 or the virtual camera operation UI 330.

An image which has undergone the rendering processing is transmitted from the back end server 270 to the end user terminal 190. A user who operates the end user terminal 190 can view an image and listen to a sound according to the designated viewpoint.

The control station 310 stores in the database 250 in advance the three-dimensional model of a target stadium or the like for which a virtual viewpoint image is generated. Furthermore, the control station 310 executes calibration at the time of placing cameras. More specifically, a marker is set on an image-capturing target field, and the position and orientation of each camera in the world coordinate system and its focal length are calculated from an image captured by each camera 112. Information of the calculated position, orientation, and focal length of each camera is stored in the database 250. The back end server 270 reads out the stadium three-dimensional model and the information of each camera that have been stored, and uses them when generating a virtual viewpoint image. The front end server 230 also reads out the information of each camera and uses it when generating an object three-dimensional model.

In this manner, the image processing system 100 includes three functional domains, that is, a video collection domain, a data storage domain, and a video generation domain. The video collection domain includes the sensor systems 110a to 110z, and the data storage domain includes the database 250, the front end server 230, and the back end server 270. The video generation domain includes the virtual camera operation UI 330 and the end user terminal 190. The arrangement is not limited to this. For example, the virtual camera operation UI 330 can also directly obtain images from the sensor systems 110a to 110z. Note that the image processing system 100 is not limited to the above-described physical arrangement and may have a logical arrangement.

<Back End Server>

In the first embodiment, an image is obtained in consideration of the positional relationship between a camera, an object three-dimensional model, and a virtual viewpoint in order to generate a virtual viewpoint image. That is, a method will be described in which an image free from any ineffective pixel generated by occlusion is obtained based on information of a camera, information of a designated virtual viewpoint, position information of an object three-dimensional model, and its hull information.

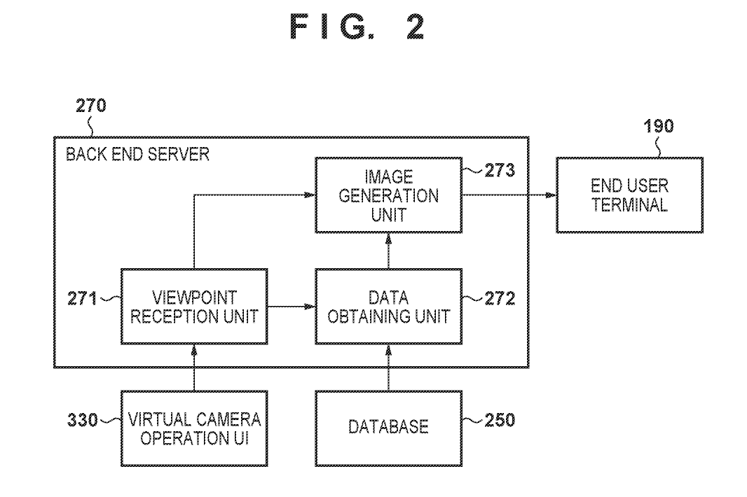

FIG. 2 is a block diagram showing the relationship between the internal blocks of the back end server 270 and peripheral devices according to the first embodiment. Referring to FIG. 2, the back end server 270 includes a viewpoint reception unit 271, a data obtaining unit 272, and an image generation unit 273.

The viewpoint reception unit 271 outputs information of a virtual viewpoint (to be referred to as virtual viewpoint information hereinafter) input from the virtual camera operation UI 330 to the data obtaining unit 272 and the image generation unit 273. The virtual viewpoint information is information representing a virtual viewpoint at a given time. The virtual viewpoint is expressed by, for example, the position, orientation, and angle of view of a virtual viewpoint in the world coordinate system.

The data obtaining unit 272 obtains data necessary to generate a virtual viewpoint image, from the database 250 based on the virtual viewpoint information input from the virtual camera operation UI 330. The data obtaining unit 272 outputs the obtained data to the image generation unit 273. The data obtained here are a foreground image (texture image) and background image generated from an image captured at a time designated by the virtual viewpoint information. Details of the data obtaining method will be described later.

The image generation unit 273 generates a virtual viewpoint image using the virtual viewpoint information input from the virtual camera operation UI 330 and the texture image and background image input from the data obtaining unit 272. More specifically, the image generation unit 273 colors an object three-dimensional model using the texture image and generates an object image. The image generation unit 273 transforms this object image and the obtained background image into an image viewed from the virtual viewpoint by geometric transformation based on the virtual viewpoint information and information of, for example, the position, posture, and focal length of a camera used for capturing. Then, the image generation unit 273 composes the background image and the object image, generating a virtual viewpoint image. As for generation of the object image and the background image, a plurality of images may be composed and combined. This virtual viewpoint image generation method is merely an example, and the processing order and the processing method are not particularly limited.

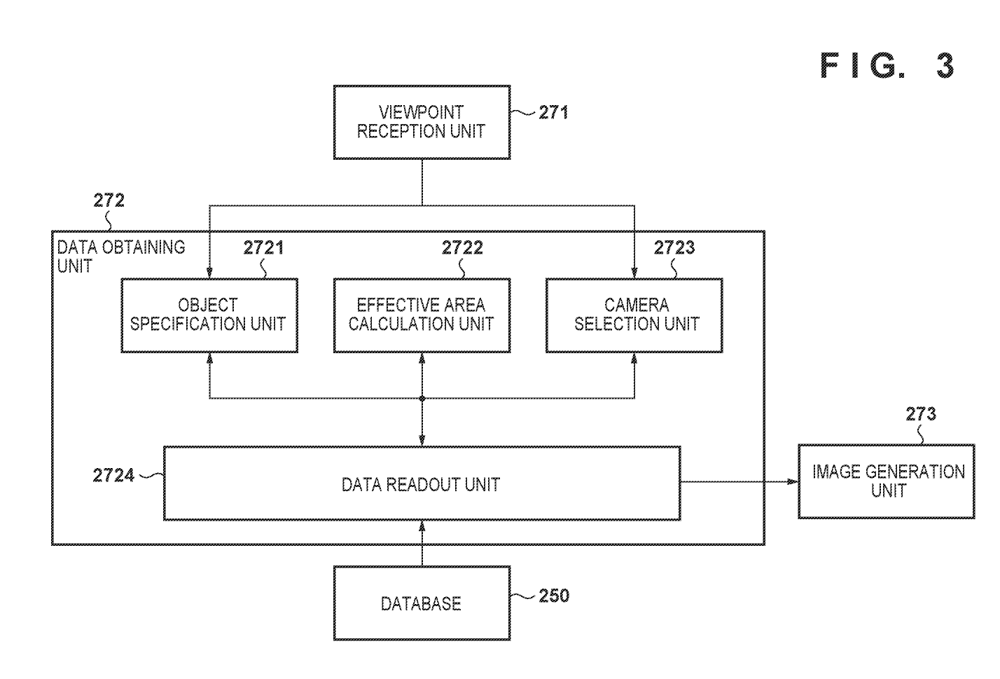

FIG. 3 is a block diagram showing the detailed arrangement of the data obtaining unit 272. Referring to FIG. 3, the data obtaining unit 272 includes an object specification unit 2721, an effective area calculation unit 2722, a camera selection unit 2723, and a data readout unit 2724.

The object specification unit 2721 obtains the virtual viewpoint information from the viewpoint reception unit 271, and the position and hull information of an object three-dimensional model obtained from the database 250 via the data readout unit 2724. Based on these pieces of information, the object specification unit 2721 specifies an object to be displayed on the designated virtual viewpoint image.

More specifically, a perspective projection method is used. The object specification unit 2721 projects the object three-dimensional model obtained from the database 250 on a projection plane determined based on the virtual viewpoint information, and specifies an object projected on the projection plane. The projection plane determined based on the virtual viewpoint information represents a range viewed from the virtual viewpoint based on the position, orientation, and angle of view of the virtual viewpoint. However, the method is not limited to the perspective projection method and is arbitrary as long as an object included in the range viewed from the designated virtual viewpoint can be specified.

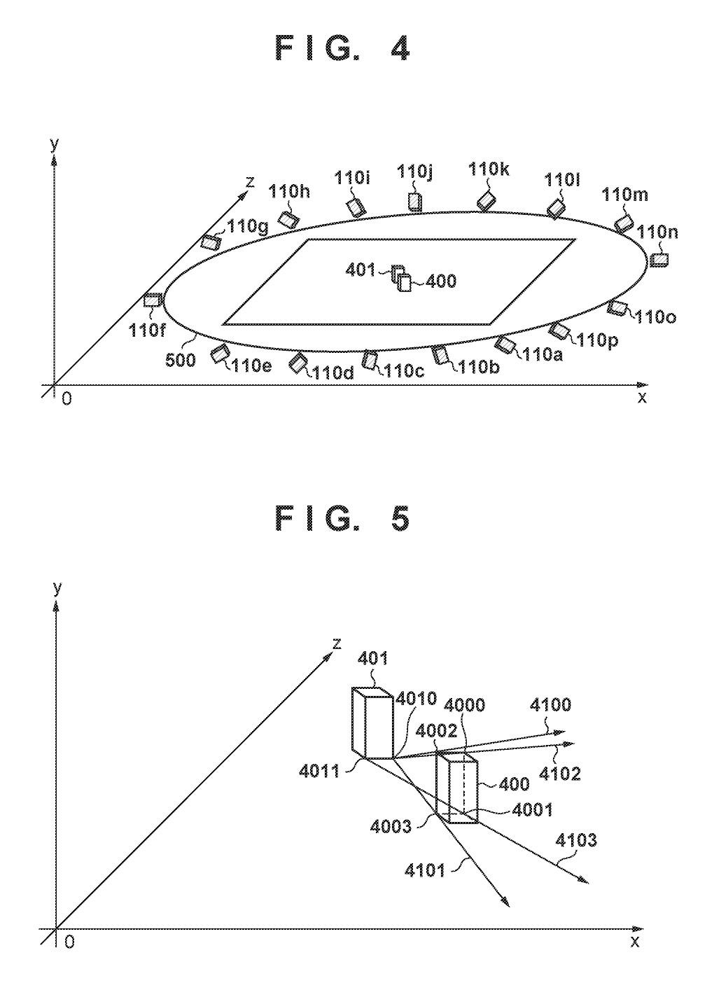

The effective area calculation unit 2722 performs the following processing for each object specified by the object specification unit 2721. That is, the effective area calculation unit 2722 calculates the coordinate range (to be referred to as an effective area hereinafter) of an image-capturing position at which a target object is not occluded by other objects and the entire object can be captured. Calculation of the effective area uses the virtual viewpoint information input from the viewpoint reception unit 271, and the position and hull information of the object three-dimensional model obtained from the database 250 by the data readout unit 2724. Note that this processing is performed for each object specified by the object specification unit 2721, and an effective area is calculated for each object. The effective area calculation method will be explained in detail with reference to FIGS. 4 and 5.

The camera selection unit 2723 selects a camera that captured a texture image used to generate a virtual viewpoint image. That is, the camera selection unit 2723 selects a camera based on the virtual viewpoint information and the effective area calculated by the effective area calculation unit 2722 for each object specified by the object specification unit 2721. For example, the camera selection unit 2723 selects two cameras based on the effective area of the object calculated by the effective area calculation unit 2722 and the position and orientation of the virtual viewpoint. At this time, weight is put on the fact that the orientation of the virtual viewpoint and the camera posture (image-capturing direction) are close. When the orientation of the virtual viewpoint and the posture (orientation) of a camera are different by a predetermined threshold angle or larger, the camera is excluded from selection targets. In other words, a camera for which the difference between the orientation of the virtual viewpoint and the camera posture falls within a predetermined range is selected. Although the number of cameras to be selected is two (a predetermined number) here, a larger number of cameras may be selected. The camera selection method is not particularly limited as long as a camera positioned in the effective area is targeted.

The data readout unit 2724 obtains from the database 250 for each object the texture image captured by the camera selected by the camera selection unit 2723. The data readout unit 2724 has a function (function as a model obtaining unit) of obtaining position information and hull information of an object three-dimensional model, a function of obtaining a background image, a function of obtaining camera information such as the position, posture, and focal length of each camera at global coordinates, and a function of obtaining a stadium three-dimensional model.

A method of calculating, by the effective area calculation unit 2722, an effective area where an entire object can be captured will be explained in detail with reference to FIGS. 4 and 5.

FIG. 4 is a schematic view showing a state in which two objects exist in a stadium where a plurality of cameras are arranged. As shown in FIG. 4, the sensor systems 110a to 110p are placed around the stadium and the image-capturing area is, for example, the field of the stadium. Objects 400 and 401 are the hulls of object three-dimensional models such as real players and are represented by hull information. A virtual viewpoint 500 is a designated virtual viewpoint.

FIG. 5 is an enlarged view of the area of the objects 400 and 401 in FIG. 4. An effective area where the object 401 is not occluded by the object 400 will be explained with reference to FIG. 5.

Referring to FIG. 5, vertices 4000 to 4003 are the vertices of the hull of the object 400, and vertices 4010 and 4011 are the vertices of the hull of the object 401. A straight line 4100 is a straight line that connects the vertices 4010 and 4002, and a straight line 4101 is a straight line that connects the vertices 4010 and 4003. Similarly, a straight line 4102 is a straight line that connects the vertices 4011 and 4000, and a straight line 4103 is a straight line that connects the vertices 4011 and 4001.

When calculating the effective area of the object 401, the effective area calculation unit 2722 determines, from the position and hull information of an object three-dimensional model, whether another object exists in the direction towards the circumference of the stadium. In the example shown in FIG. 5, the object 400 exists.

Then, the effective area calculation unit 2722 calculates a coordinate range where the entire object 401 can be captured without occlusion by the object 400. For example, a boundary at which the vertex 4010 of the object 401 cannot be viewed is a plane including the straight lines 4100 and 4101. Also, a boundary at which the vertex 4011 of the object 400 cannot be viewed is a plane including the straight lines 4102 and 4103. Hence, the outside of an area defined by a plane including the straight lines 4100 and 4101 and the plane including the straight lines 4102 and 4103 is calculated as an effective area where the entire object 401 can be captured without occlusion by the object 400.

Although a target object is occluded by another object in this example, an effective area can be calculated even in a case in which a target object is occluded by a plurality of objects. In this case, an effective area is calculated in order for a plurality of objects, and a range excluding areas outside the effective areas of the respective objects is calculated as a final effective area.

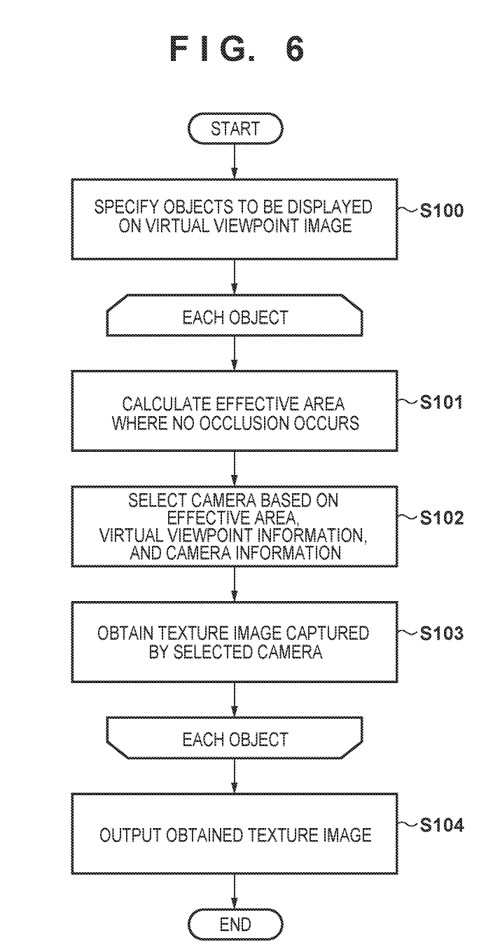

FIG. 6 is a flowchart showing processing of obtaining an image for generating a virtual viewpoint image according to the first embodiment. Note that processing to be described below is implemented by control of the controller 300 unless specifically stated otherwise. That is, the controller 300 controls the other devices (for example, the back end server 270 and the database 250) in the image processing system 100, thereby implementing control of the processing shown in FIG. 6.

In step S100, the object specification unit 2721 specifies objects to be displayed on a designated virtual viewpoint image based on virtual viewpoint information from the viewpoint reception unit 271 and the position and hull information of an object three-dimensional model obtained from the data readout unit 2724. In the example of FIG. 4, the objects 400 and 401 included in a range viewed from the virtual viewpoint 500 are specified.

Processes in steps S101 to S103 below are performed for each object specified in step S100.

In step S101, the effective area calculation unit 2722 calculates an area where no occlusion occurs, that is, an effective area where the entire object specified in step S100 can be captured. In the example of FIG. 5, when the object 401 is a target object, the outside of an area defined by a plane including the straight lines 4100 and 4101 and a plane including the straight lines 4102 and 4103 is calculated as an effective area. Also, when the object 400 is a target object, an effective area is calculated by the above-mentioned method.

In step S102, the camera selection unit 2723 selects a camera based on the effective area calculated by the effective area calculation unit 2722, virtual viewpoint information, and camera information for each object specified by the object specification unit 2721. In the example of FIGS. 4 and 5, the camera selection unit 2723 selects two sensor systems 110d and 110p that are positioned in the effective area and have camera postures close to the orientation of the virtual viewpoint 500.

In step S103, the data readout unit 2724 obtains texture images based on image-capturing by the cameras selected in step S102.

The above processes are executed for all objects specified by the object specification unit 2721 in step S100.

In step S104, the data readout unit 2724 outputs the texture images obtained in step S103 to the image generation unit 273.

A circumscribed rectangular parallelepiped has been explained as hull information for descriptive convenience in this embodiment, but the present invention is not limited to this. It is also possible that a rough effective area is determined based on a circumscribed rectangle and then an effective area of an accurate shape is determined using information of the shape of an object three-dimensional model.

A case in which the number of objects causing occlusion is one has been explained in this embodiment, but the present invention is not limited to this. Even when the number of objects causing occlusion is two, effective areas are calculated in order for a plurality of three-dimensional models and an effective area where none of objects are occluded is calculated, as described above. After that, a virtual viewpoint image can be generated using images captured by cameras present in the effective area.

<Hardware Configuration>

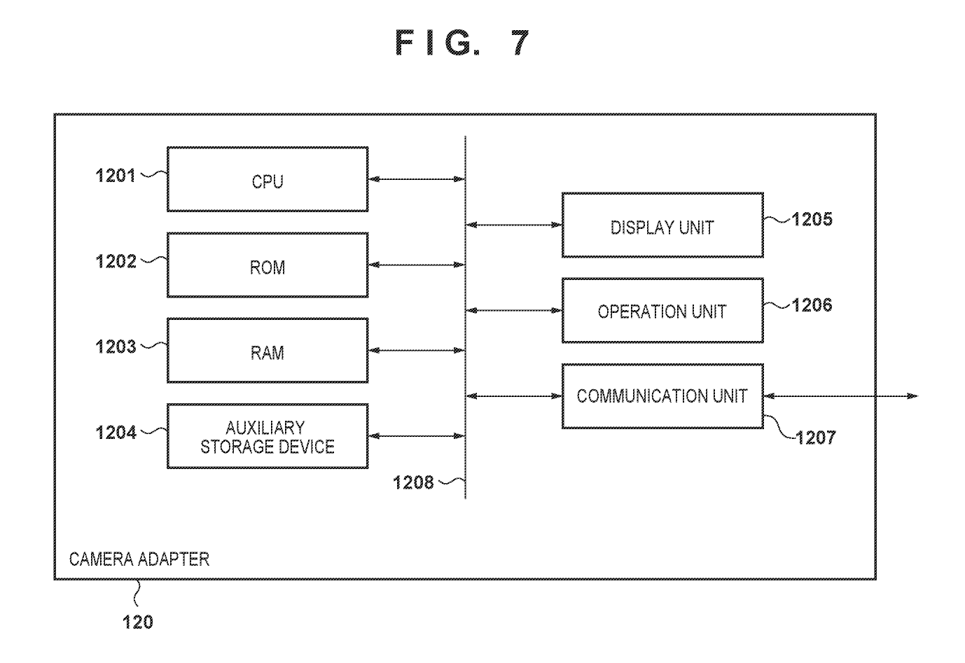

The hardware configuration of each device constituting this embodiment will be described next. FIG. 7 is a block diagram showing the hardware configuration of the camera adapter 120.

The camera adapter 120 includes a CPU 1201, a ROM 1202, a RAM 1203, an auxiliary storage device 1204, a display unit 1205, an operation unit 1206, a communication unit 1207, a bus 1208.

The CPU 1201 controls the overall camera adapter 120 using computer programs and data stored in the ROM 1202 and the RAM 1203. The ROM 1202 stores programs and parameters that do not require change. The RAM 1203 temporarily stores programs and data supplied from the auxiliary storage device 1204, and data and the like supplied externally via the communication unit 1207. The auxiliary storage device 1204 is formed from, for example, a hard disk drive and stores content data such as still images and moving images.

The display unit 1205 is formed from, for example, a liquid crystal display and displays, for example, a GUI (Graphical User Interface) for operating the camera adapter 120 by the user. The operation unit 1206 is formed from, for example, a keyboard and a mouse, receives an operation by the user, and inputs various instructions to the CPU 1201. The communication unit 1207 communicates with external devices such as the camera 112 and the front end server 230. The bus 1208 connects the respective units of the camera adapter 120 and transmits information.

Note that devices such as the front end server 230, the database 250, the back end server 270, the control station 310, the virtual camera operation UI 330, and the end user terminal 190 can also be included in the hardware configuration in FIG. 7. The functions of the above-described devices may be implemented by software processing using the CPU or the like.

By executing the above-described processing, an effective area where no occlusion occurs can be calculated for each object in advance, and an ineffective pixel-free image captured by a camera present in the effective area can be obtained. This obviates processing of, when it is determined after obtaining an image that there are ineffective pixels generated by occlusion, obtaining an image captured again by another camera. This can shorten the data obtaining time and implement high-speed image processing.

### Second Embodiment

The second embodiment will be described below. In the first embodiment, an area where ineffective pixels are generated due to occlusion is calculated in advance for one object, and only an image captured at a position where no ineffective pixel is generated is obtained and used to generate a virtual viewpoint image.

To the contrary, in the second embodiment, pixels (to be referred to as effective pixels hereinafter) corresponding to an area where no occlusion occurs are calculated for an image captured by a camera arranged outside the effective area, and the effective pixels are used to generate a virtual viewpoint image. It becomes more likely to use an image that includes ineffective pixels generated by occlusion but is captured by a camera closer to a virtual viewpoint, thus improving the image quality. Examples are a case in which ineffective pixels are generated by occlusion but the image can be used for the pixels of a texture image to be displayed on a virtual viewpoint image, and a case in which a virtual viewpoint image can be generated by combining images from a plurality of cameras.

If it is determined whether ineffective pixels are generated by occlusion for one object, as in the first embodiment, it is determined that there is no available image in a case in which occlusion occurs in all cameras arranged actually. According to the method of the second embodiment, even in a case in which occlusion occurs in all cameras, a virtual viewpoint image can be generated by combining images from a plurality of cameras, and robustness against occlusion improves.

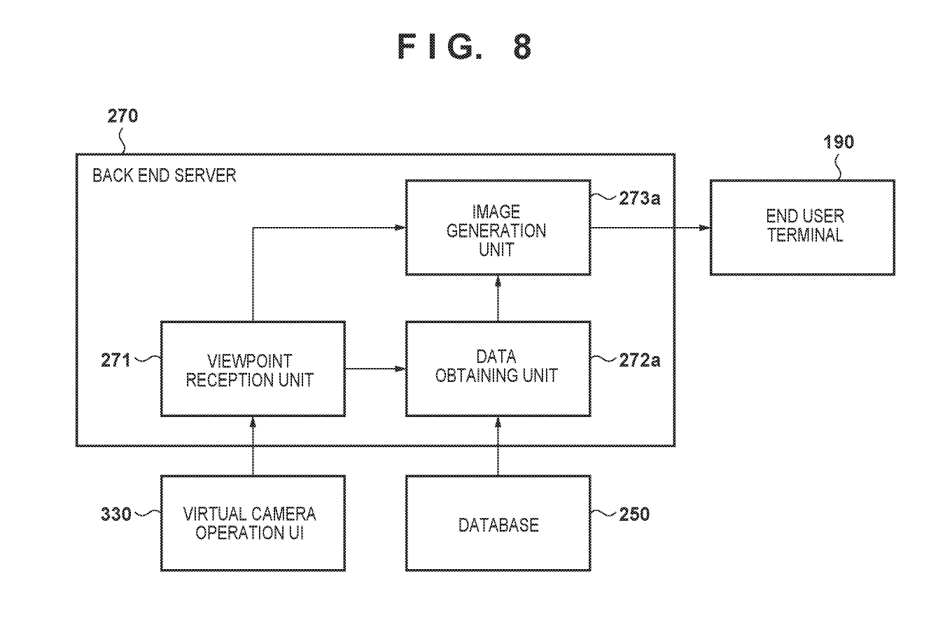

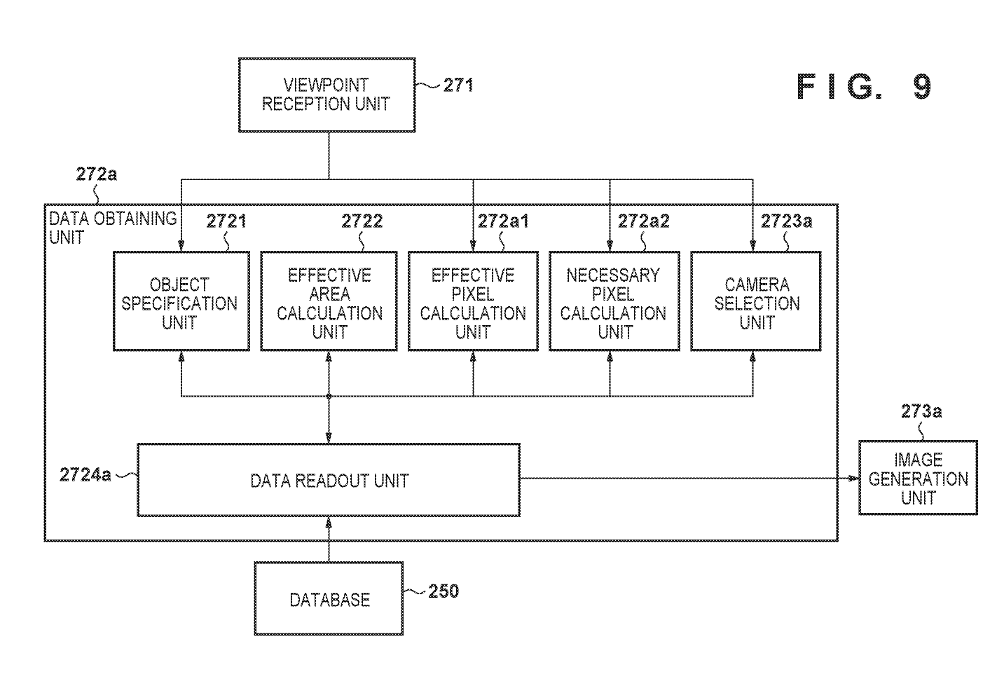

FIG. 8 is a block diagram showing the relationship between the internal blocks of a back end server 270 and peripheral devices according to the second embodiment. The same reference numerals as those in the first embodiment denote the same blocks and a description thereof will be omitted.

A data obtaining unit 272a determines whether to use even an image captured by a camera arranged outside an effective area for generation of a virtual viewpoint image. The data obtaining unit 272a obtains an image from a camera selected based on this determination.

An image generation unit 273a generates a virtual viewpoint image by composing a texture image obtained from the camera by the data obtaining unit 272a.

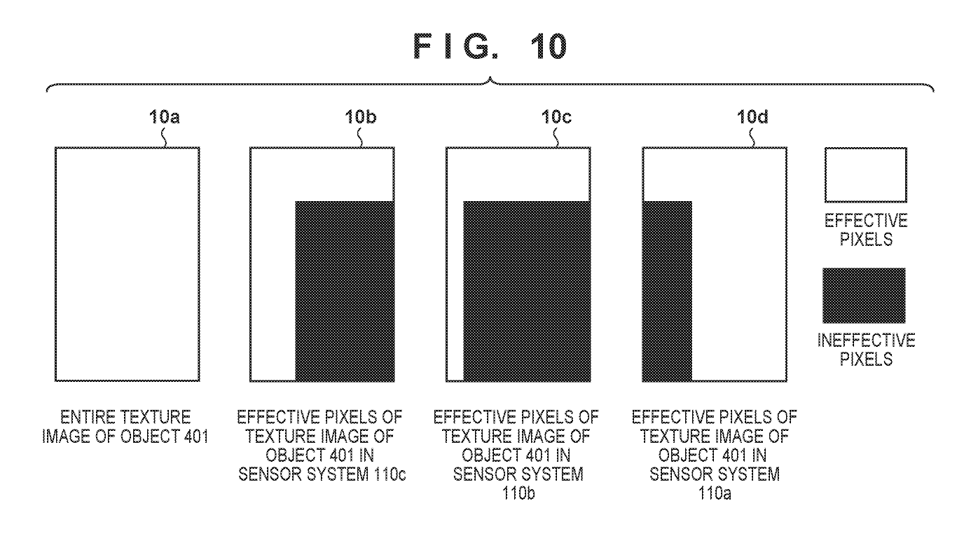

FIG. 9 is a block diagram showing the data obtaining unit 272a according to the second embodiment. A description of blocks denoted by the same reference numerals as those in the first embodiment will not be repeated.

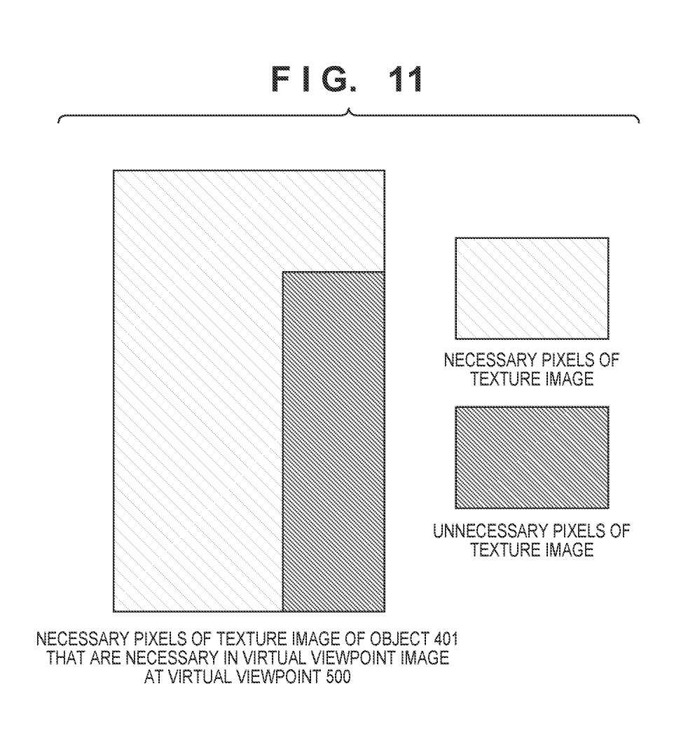

An effective pixel calculation unit 272a1 determines whether each pixel of a texture image from each camera arranged outside an effective area calculated by an effective area calculation unit 2722 is an effective pixel free from occlusion. Thus the effective pixel calculation unit 272a1 calculates effective pixels. The calculation method will be described in detail with reference to FIG. 10.

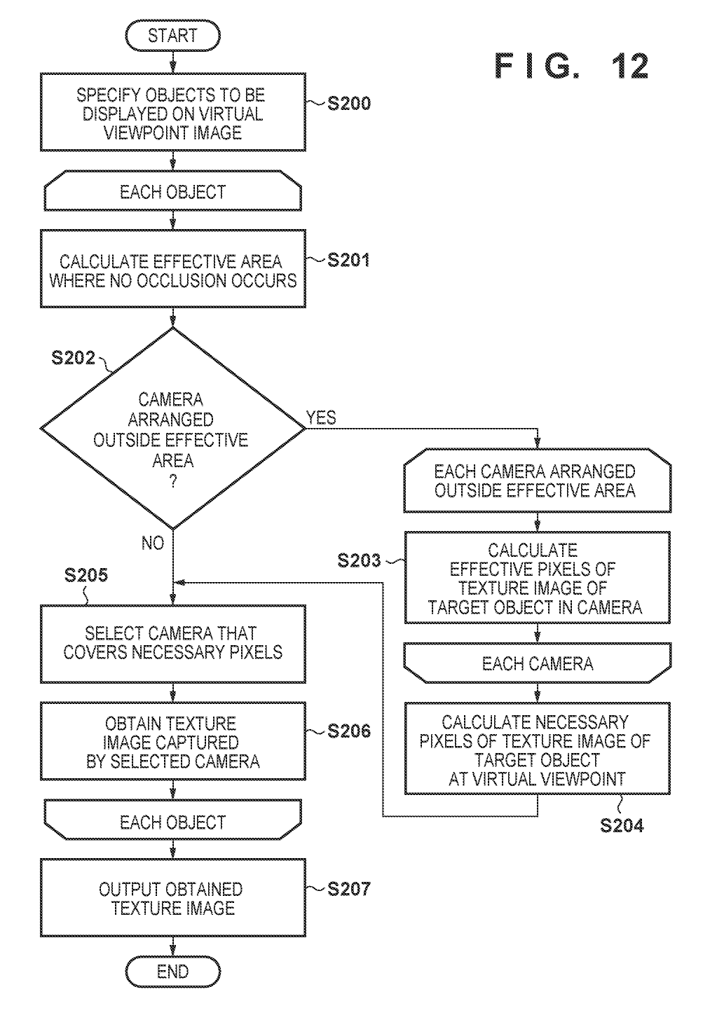

For each object calculated by an object specification unit 2721, a necessary pixel calculation unit 272a2 calculates pixels (to be referred to as necessary pixels hereinafter) used to generate a virtual viewpoint image designated by a viewpoint reception unit 271. The calculation method will be described in detail with reference to FIG. 11.

A camera selection unit 2723a selects one or more cameras to capture an image that covers all necessary pixels of the texture image of an object. A camera selection method will be explained later. In this embodiment, priority is given to cameras close to a virtual viewpoint. For example, it is made a condition that two cameras complete a texture image capable of generating all pixels necessary to generate an image at a designated virtual viewpoint.

However, the condition of the number of cameras to be selected is not limited to this. For example, cameras may be selected to minimize the number of cameras to be selected, instead of giving priority to cameras close to a virtual viewpoint. It is also possible to give priority to a camera closest to a virtual viewpoint and additionally select a camera until necessary pixels can be covered. If all cameras cannot complete necessary pixels, a texture image that covers as many necessary pixels as possible may be obtained, and a complementary unit may be adopted to complement the remaining uncovered necessary pixels from neighboring effective pixels by image processing.

A data readout unit 2724a obtains from a database 250 for each object a texture image captured by the camera selected by the camera selection unit 2723a. The data readout unit 2724a has a function as a model obtaining unit for obtaining an object three-dimensional model and its position information and hull information, a function of obtaining a background image, a function of obtaining camera information such as the position, posture, and focal length of each camera at global coordinates, and a function of obtaining a stadium three-dimensional model.

Next, a method of calculating effective pixels and necessary pixels mentioned above, and a camera selection method based on the calculation results will be explained in detail with reference to the example in FIG. 4. In FIG. 4, a virtual viewpoint 500 is designated in a situation in which objects 400 and 401 of a three-dimensional model exist. At this time, assume that sensor systems arranged outside (coordinate range where it is determined that occlusion occurs) an effective area calculated by the effective area calculation unit 2722 are sensor systems 110a, 110b, and 110c.

First, an effective pixel calculation method will be explained with reference to FIG. 10. FIG. 10 is a view showing the texture image of the object 401. In FIG. 10, reference numeral 10a denotes an entire texture image when the object 401 is viewed from the line-of-sight direction of the virtual viewpoint 500. Reference numerals 10b to 10d denote texture images from the sensor systems 110c, 110b, and 110a. In FIG. 10, a black area represents ineffective pixels generated by occlusion, and the remaining area represents effective pixels. That is, the texture image 10a represents an image in which the object 401 is not occluded by another object, and the texture images 10b to 10d represent images in which the object 401 is occluded by the object 400.

A perspective projection method is used to calculate effective pixels. First, the object 401 of a three-dimensional model is projected on a projection plane determined from information such as the position, posture, and focal length of the camera of each of the sensor systems 110a, 110b, and 110c at global coordinates. Further, the object 400 is projected. This clarifies an area where the projected objects overlap each other and an area where they do not overlap each other. Pixels corresponding to an area where the objects do not overlap each other in a texture image from each sensor system are calculated as effective pixels.

Next, a necessary pixel calculation method will be explained with reference to FIG. 11. FIG. 11 is a view showing pixels necessary to generate an image at the virtual viewpoint 500 in the texture image of the object 401. As described above, the entire texture image of the object 401 is one as represented by the texture image 10a. However, when the object 401 is viewed from the position of the designated virtual viewpoint 500, the lower right portion of the object 401 is occluded by the object 400. In the example of FIG. 11, pixels corresponding to the portion occluded by the object 400 in the texture image are pixels (to be referred to as unnecessary pixels hereinafter) not used to generate a virtual viewpoint image. Pixels other than the unnecessary pixels, that is, pixels (area excluding the lower right portion) corresponding to the partial area of the object 401 included in the virtual viewpoint image are pixels necessary to generate a virtual viewpoint image.

Similar to the above-described calculation of effective pixels, a perspective projection method is used to calculate necessary pixels. First, the target object 401 is projected on a projection plane determined based on virtual viewpoint information. Then, the object 400 between the target object 401 and the virtual viewpoint 500 is projected similarly. Pixels corresponding to an area where the objects overlap each other cannot be viewed from the virtual viewpoint 500 and thus are unnecessary pixels. The remaining pixels serve as necessary pixels.

A camera selection method based on the calculation results of effective pixels and necessary pixels will be explained next. As described above, generation of the virtual viewpoint image of a target object requires only the pixel values of necessary pixels out of a texture image. In this embodiment, the pixel values of effective pixels corresponding to the respective positions of necessary pixels are used as the pixel values of necessary pixels.

In the example of FIGS. 10 and 11, all pixels (FIG. 11) necessary to generate an image viewed from the virtual viewpoint 500 can be covered by the effective pixels of the texture images 10b and 10d from the sensor systems 110c and 110a among images from the sensor systems arranged outside the effective area. Therefore, the camera selection unit 2723a selects the sensor systems 110c and 110a.

FIG. 12 is a flowchart showing processing of obtaining an image for generating a virtual viewpoint image according to the second embodiment. Note that processing to be described below is implemented by control of a controller 300 unless specifically stated otherwise. That is, the controller 300 controls the other devices (for example, the back end server 270 and the database 250) in the image processing system 100, thereby implementing the control.

In step S200, the object specification unit 2721 specifies objects to be displayed on a virtual viewpoint image based on virtual viewpoint information input from the viewpoint reception unit 271 and the position and hull information of an object three-dimensional model obtained from the data readout unit 2724a.

Processes in steps S201 to S206 below are performed for each object specified in step S200.

In step S201, the effective area calculation unit 2722 calculates an area where no occlusion occurs, that is, an effective area where the entire object specified in step S200 can be captured.

In step S202, the effective pixel calculation unit 272a1 determines based on the calculation result of the effective area calculation unit 2722 whether cameras are arranged outside the effective area for the target object. If no camera is arranged outside the effective area (NO in step S202), the process advances to step S205. If cameras are arranged outside the effective area (YES in step S202), the process advances to step S203.

Processing in step S203 targets cameras arranged outside the effective area and is performed for each camera.

In step S203, the effective pixel calculation unit 272a1 calculates effective pixels by determining whether each pixel of the texture image of the target object captured by the target camera is effective. As described above, effective pixels are pixels captured without occlusion by another object.

In step S204, the necessary pixel calculation unit 272a2 calculates the necessary pixels of the texture image of the target object at a virtual viewpoint.

In step S205, the camera selection unit 2723a selects a camera that captured an image used to generate the texture image of the target object. That is, the camera selection unit 2723a selects a plurality of cameras to cover all necessary pixels in accordance with the positional relationship between the camera and the virtual viewpoint, the camera posture, and the orientation of the virtual viewpoint. In the example of FIG. 4, the camera selection unit 2723a selects two cameras close to the virtual viewpoint, that is, the sensor systems 110c and 110a.

In step S206, the data readout unit 2724a obtains texture images captured by the cameras selected in step S205.

The above processes are executed for all objects specified by the object specification unit 2721 in step S200.

In step S207, the data readout unit 2724a outputs the images obtained in step S206 to the image generation unit 273a.

According to the second embodiment, it is determined for each pixel whether occlusion has occurred. In addition to the effects of the first embodiment, the second embodiment has effects of enabling selection of a texture image from a camera closer to a virtual viewpoint, improving the image quality, and improving robustness against occlusion.

### Third Embodiment

The third embodiment will be explained below. In the third embodiment, an example will be described in which when writing an object three-dimensional model in a storage device (for example, a database 250), an effective area where no occlusion occurs is calculated for each object, and the object three-dimensional model is written in association with this information.

When generating a virtual viewpoint image, an ineffective pixel-free texture image can be easily selected. At the time of generating a virtual viewpoint, the data obtaining time of a texture image can be shortened, enabling high-speed processing.

The effects of the third embodiment are the same as those of the first embodiment except that the method is different.

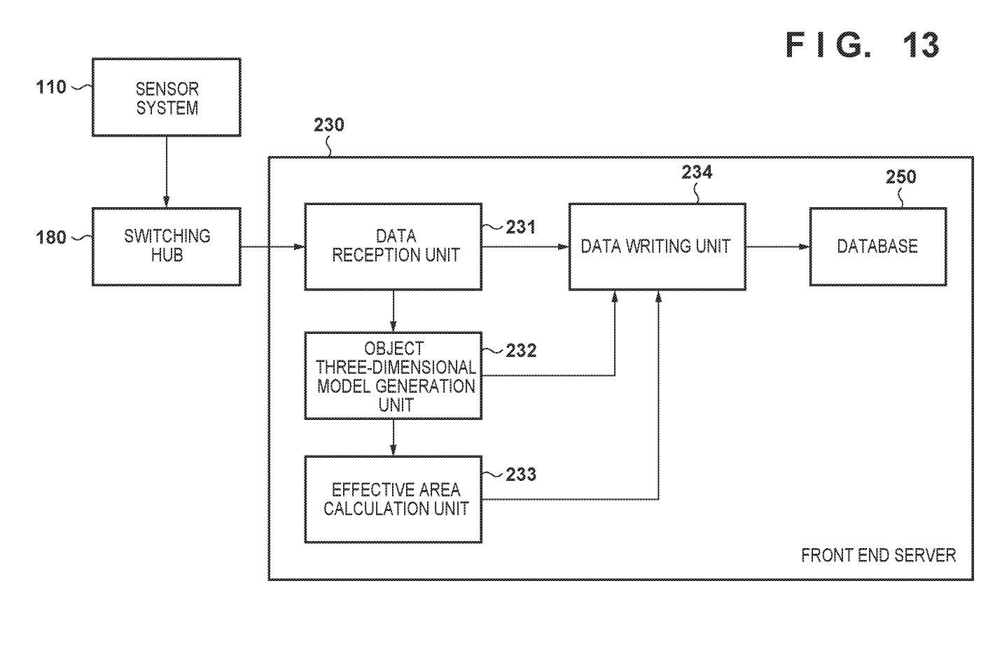

FIG. 13 is a block diagram showing the relationship between the internal blocks of a front end server 230 and peripheral devices according to the third embodiment.

A data reception unit 231 receives a foreground image and a background image from a sensor system 110 via a switching hub 180, and outputs them to an object three-dimensional model generation unit 232 and a data writing unit 234.

The object three-dimensional model generation unit 232 generates an object three-dimensional model from the foreground image using the Visual Hull method. The object three-dimensional model generation unit 232 outputs the object three-dimensional model to an effective area calculation unit 233 and the data writing unit 234.

Based on the received object three-dimensional model, the effective area calculation unit 233 calculates for each object an effective area where occlusion by another object does not occur. The calculation method is the same as the method described for the effective area calculation unit 2722 according to the first embodiment. Further, the effective area calculation unit 233 selects a camera arranged in the calculated effective area as an effective camera based on camera information of the positions, postures, and focal lengths of cameras placed in the system. Furthermore, the effective area calculation unit 233 generates camera information of the effective camera as effective camera information for each object, and outputs the effective camera information to the data writing unit 234.

The data writing unit 234 writes in the database 250 the foreground image and background image received from the data reception unit 231 and the object three-dimensional model received from the object three-dimensional model generation unit 232. The data writing unit 234 writes the object three-dimensional model in association with at least either the effective area or the effective camera information.

According to the third embodiment, an object three-dimensional model is written in the database 250 (storage device) in association with information used to select an ineffective pixel-free texture image. At the time of generating a virtual viewpoint, the data obtaining time of a texture image can be shortened, enabling high-speed processing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-Ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-209564, filed Oct. 30, 2017, which is hereby incorporated by reference herein in its entirety.

What is claimed is:

1. An image processing apparatus comprising:
a model obtaining unit configured to obtain a three-dimensional shape model representing a shape of an object captured from a plurality of directions by a plurality of image-capturing apparatuses arranged at different positions;
a viewpoint obtaining unit configured to obtain viewpoint information representing a virtual viewpoint;
an image obtaining unit configured to obtain, as an image used to generate a virtual viewpoint image including at least one of a plurality of objects captured by the plurality of image-capturing apparatuses, an image based on image-capturing by an image-capturing apparatus selected based on a positional relationship between the plurality of objects, a position and orientation of an image-capturing apparatus included in the plurality of image-capturing apparatuses, and a position of the virtual viewpoint represented by the viewpoint information obtained by the viewpoint obtaining unit; and
an image generation unit configured to generate the virtual viewpoint image based on the three-dimensional shape model obtained by the model obtaining unit and the image obtained by the image obtaining unit.

2. The apparatus according to claim 1, further comprising:
an object specification unit configured to specify an object to be displayed on the virtual viewpoint image corresponding to the virtual viewpoint represented by the viewpoint information based on the viewpoint information obtained by the viewpoint obtaining unit and the three-dimensional shape model obtained by the model obtaining unit,
wherein the image obtaining unit obtains, as the image used to generate the virtual viewpoint image including the specified object, the image based on image-capturing by the image-capturing apparatus selected from the plurality of image-capturing apparatuses based on a positional relationship between the object specified by the object specification unit and another object, and the position and orientation of the image-capturing apparatus included in the plurality of image-capturing apparatuses.

3. The apparatus according to claim 2, further comprising:
a selection unit configured to select from the plurality of image-capturing apparatuses an image-capturing apparatus that captures the specified object without occlusion by the other object, based on the positional relationship between the object specified by the object specification unit and the other object, and a position and orientation of an image-capturing apparatus included in the plurality of image-capturing apparatuses,
wherein the image obtaining unit obtains the image based on image-capturing by the image-capturing apparatus selected by the selection unit as the image used to generate the virtual viewpoint image including the specified object.

4. The apparatus according to claim 3, wherein when at least two image-capturing apparatuses capture the specified object without occlusion by the other object, the selection unit selects from the at least two image-capturing apparatuses an image-capturing apparatus for which a difference between an image-capturing direction and an orientation of the virtual viewpoint represented by the viewpoint information obtained by the viewpoint obtaining unit falls within a predetermined range.

5. The apparatus according to claim 3, further comprising:
a determination unit configured to determine a partial area of the object specified by the object specification unit that is a partial area included in the virtual viewpoint image corresponding to the virtual viewpoint represented by the viewpoint information obtained by the viewpoint obtaining unit,
wherein the selection unit selects from the plurality of image-capturing apparatuses an image-capturing apparatus that captures, without occlusion by the other object, the partial area of the specified object determined by the determination unit.

6. The apparatus according to claim 1, wherein the image generation unit generates, by interpolation processing based on the obtained image, an image of a partial area not included in the image obtained by the image obtaining unit that is a partial area of the virtual viewpoint image.

7. The apparatus according to claim 3, wherein the selection unit selects a predetermined number of image-capturing apparatuses.

8. The apparatus according to claim 1, wherein the three-dimensional shape model includes at least information of a hull and position of the object.

9. The apparatus according to claim 1, wherein the viewpoint information includes at least a position, orientation, and angle of view of the virtual viewpoint.

10. The apparatus according to claim 1, wherein the image obtaining unit uses at least positions, postures, and focal lengths of the plurality of image-capturing apparatuses when obtaining the image used to generate the virtual viewpoint image.

11. The apparatus according to claim 1, wherein the image obtained by the image obtaining unit is a texture image generated from an image captured by the image-capturing apparatus.

12. The apparatus according to claim 2, further comprising:
a selection unit configured to select from the plurality of image-capturing apparatuses an image-capturing apparatus that captures a peripheral area of the specified object without occlusion by a peripheral area of the other object, based on the positional relationship between the object specified by the object specification unit and the other object, and a position and orientation of an image-capturing apparatus included in the plurality of image-capturing apparatuses,
wherein the image based on image-capturing by the image-capturing apparatus selected by the selection unit is obtained as the image used to generate the virtual viewpoint image including the specified object.

13. The apparatus according to claim 12, wherein the peripheral area of the object is an area of a predetermined shape including the object.

14. An image processing method comprising:
obtaining a three-dimensional shape model representing a shape of an object captured from a plurality of directions by a plurality of image-capturing apparatuses arranged at different positions;
obtaining viewpoint information representing a virtual viewpoint;
obtaining, as an image used to generate a virtual viewpoint image including at least one of a plurality of objects captured by the plurality of image-capturing apparatuses, an image based on image-capturing by an image-capturing apparatus selected based on a positional relationship between the plurality of objects, a position and orientation of an image-capturing apparatus included in the plurality of image-capturing apparatuses, and a position of the virtual viewpoint represented by the obtained viewpoint information; and
generating the virtual viewpoint image based on the obtained three-dimensional shape model and the obtained image.

15. The method according to claim 14, further comprising specifying an object to be displayed on the virtual viewpoint image corresponding to the virtual viewpoint represented by the viewpoint information based on the obtained viewpoint information and the obtained three-dimensional shape model,
wherein in obtaining the image, an image based on image-capturing by an image-capturing apparatus selected from the plurality of image-capturing apparatuses based on a positional relationship between the specified object and another object, and a position and orientation of an image-capturing apparatus included in the plurality of image-capturing apparatuses is obtained as the image used to generate the virtual viewpoint image including the specified object.

16. The method according to claim 14, further comprising selecting an image-capturing apparatus that captures the specified object without occlusion by the other object from the plurality of image-capturing apparatuses based on the positional relationship between the specified object and the other object, and a position and orientation of an image-capturing apparatus included in the plurality of image-capturing apparatuses,
wherein in obtaining the image, the image based on image-capturing by the selected image-capturing apparatus is obtained as the image used to generate the virtual viewpoint image including the specified object.

17. A non-transitory computer-readable medium storing a program configured to cause a computer to execute an image processing method, the image processing method comprising:
obtaining a three-dimensional shape model representing a shape of an object captured from a plurality of directions by a plurality of image-capturing apparatuses arranged at different positions;
obtaining viewpoint information representing a virtual viewpoint;
obtaining, as an image used to generate a virtual viewpoint image including at least one of a plurality of objects captured by the plurality of image-capturing apparatuses, an image based on image-capturing by an image-capturing apparatus selected based on a positional relationship between the plurality of objects, a position and orientation of an image-capturing apparatus included in the plurality of image-capturing apparatuses, and a position of the virtual viewpoint represented by the obtained viewpoint information; and
generating the virtual viewpoint image based on the obtained three-dimensional shape model and the obtained image.
